(19) United States
(12) Patent Application Publication
(10) Pub. No.: US 2025/0060122 A1
(43) Pub. Date: Feb. 20, 2025

(54) MACHINE LEARNING BASED CONTROL SYSTEMS FOR HEATING VENTILATION AND COOLING SYSTEMS

(71) Applicant: BLUE FRONTIER INC., Boca Raton, FL (US)

(72) Inventors: Daniel A. BETTS, Parkland, FL (US); Matthew TILGHMAN, Pennington, NJ (US); Matthew GRAHAM, West Palm Beach, FL (US)

(73) Assignee: BLUE FRONTIER INC., Boca Raton, FL (US)

(21) Appl. No.: 18/807,250

(22) Filed: Aug. 16, 2024

Related U.S. Application Data
(60) Provisional application No. 63/520,391, filed on Aug. 18, 2023.

(51) Int. Cl. F24F 11/64; F24F 3/14; F24F 11/83; F24F 110/10; F24F 110/20; F24F 140/00; G06N 20/00

(52) U.S. Cl. CPC F24F 11/64; F24F 3/1417; F24F 11/83; G06N 20/00; F24F 2003/1458; F24F 2110/10; F24F 2110/20; F24F 2140/00

(57) ABSTRACT

The disclosure relates to machine learning and artificial intelligence based control systems for heating ventilation and cooling systems. In some examples, a computing device receives flow data characterizing flow rates of a first fluid over a time range. The computing device also receives humidity data characterizing humidity levels over the time range. Further, the computing device receives temperature data characterizing temperatures over the time range. The computing device also generates a training set of features based on the flow data, the humidity data, and the temperature data. The computing device further trains a machine learning process based on the training set of features. The computing device stores machine learning model data characterizing the trained machine learning process in a data repository.

### CROSS-REFERENCE TO RELATED APPLICATION

This application claims the benefit of priority to U.S. Provisional Patent Application No. 63/520,391, filed on Aug. 18, 2023, the entire disclosure of which is expressly incorporated herein by reference to its entirety.

### TECHNICAL FIELD

The disclosure relates generally to control systems and, more particularly, to control systems for heating ventilation and cooling systems.

### BACKGROUND

Heating ventilation and cooling (HVAC) systems generally cool ambient or room temperature air using a vapor compression refrigeration cycle. The HVAC systems may include a heat exchanger that operates to remove heat from a refrigerant. For example, the heat exchanger may include plates or coils through which the refrigerant flows. A fan may blow air across the plates or coils to cool the refrigerant flowing within. Less frequently, the heat exchangers may include a liquid desiccant to dehumidify the air during the cooling process. These HVAC systems may include a thermostat to set a desired temperature and, in some examples, a humidity level.

### SUMMARY

In some embodiments, an apparatus includes a non-transitory, machine-readable storage medium storing instructions. The apparatus also includes at least one processor coupled to the non-transitory, machine-readable storage medium. The at least one processor is configured to execute the instructions to receive flow data characterizing flow rates of a first fluid over a time range. The at least one processor is also configured to execute the instructions to receive humidity data characterizing humidity levels over the time range. Further, the at least one processor is configured to execute the instructions to receive temperature data characterizing temperatures over the time range. The at least one processor is also configured to execute the instructions to generate a training set of features based on the flow data, the humidity data, and the temperature data. The at least one processor is further configured to execute the instructions to train a machine learning process based on the training set of features. The at least one processor is also configured to execute the instructions to store machine learning model data characterizing the trained machine learning process in a data repository.

In other embodiments, a method by at least one processor includes receive flow data characterizing flow rates of a first fluid over a time range. The method also includes receiving humidity data characterizing humidity levels over the time range. Further, the method includes receiving temperature data characterizing temperatures over the time range. The method also includes generating a training set of features based on the flow data, the humidity data, and the temperature data. The method further includes training a machine learning process based on the training set of features. The method also includes storing machine learning model data characterizing the trained machine learning process in a data repository.

In yet other embodiments, a system includes a conditioner sub-system configured to condition a stream of air based on a conditioning fluid. The system also includes a regenerator sub-system configured to remove heat from the conditioning fluid. Further, the system includes a controller configured to adjust at least one control setting of one or more of the conditioner sub-system and the regenerator sub-system. The system also includes a computing device communicatively coupled to the controller. The computing device is configured to receive, from at least one sensor, sensor data characterizing at least one of: a temperature, a humidity level, and a flow rate. The computing device is also configured to generate an inference set of features based on the sensor data. Further, the computing device is configured to apply a trained machine learning process to the inference set of features to generate output data characterizing a predicted operational value of one or more of the conditioner sub-system and the regenerator sub-system during a future temporal interval. The computing device is also configured to, based on the output data, transmit a signal to the controller to adjust the at least one control setting.

### BRIEF DESCRIPTION OF THE DRAWINGS

The following drawings are illustrative of particular embodiments of the present disclosure and therefore do not limit the scope of the present disclosure. The drawings are not to scale and are intended for use in conjunction with the explanations in the following detailed description.

FIG. 1 illustrates a liquid desiccant air-conditioning (LDAC) system, in accordance with one embodiment;

FIG. 2 illustrates an exemplary LDAC control computing device of the LDAC system of FIG. 1, in accordance with one embodiment;

FIG. 3 illustrates portions of the LDAC system of FIG. 1, in accordance with one embodiment;

FIG. 4 a timeline for training and applying a machine learning process, in accordance with one embodiment;

FIG. 5 illustrates a flowchart of an example method to adjust a control setting of the LDAC system of FIG. 1, in accordance with one embodiment; and

FIG. 6 illustrates a flowchart of an example method to train a machine learning process, in accordance with one embodiment.

### DETAILED DESCRIPTION

The following discussion omits or only briefly describes conventional features of heat and mass exchangers that are apparent to those skilled in the art. It is noted that various embodiments are described in detail with reference to the drawings, in which like reference numerals represent like parts and assemblies throughout the several views. Reference to various embodiments does not limit the scope of the claims attached hereto. Additionally, any examples set forth in this specification are intended to be non-limiting and merely set forth some of the many possible embodiments for the appended claims. Further, particular features described herein can be used in combination with other described features in each of the various possible combinations and permutations.

Unless otherwise specifically defined herein, all terms are to be given their broadest reasonable interpretation including meanings implied from the specification as well as meanings understood by those skilled in the art and/or as defined in dictionaries, treatises, etc. It must also be noted that, as used in the specification and the appended claims, the singular forms “a,” “an” and “the” include plural referents unless otherwise specified, and that the terms “includes” and/or “including,” when used in this specification, specify the presence of stated features, elements, and/or components, but do not preclude the presence or addition of one or more other features, steps, operations, elements, components, and/or groups thereof. In the description, relative terms such as “horizontal,” “vertical,” “up,” “down,” “top,” and “bottom” as well as derivatives thereof (e.g., “horizontally,” “downwardly,” “upwardly,” etc.) should be construed to refer to the orientation as then described or as shown in the drawing figure under discussion. These relative terms are for convenience of description and normally are not intended to require a particular orientation. Terms including “above” versus “below,” “inwardly” versus “outwardly,” “longitudinal” versus “lateral,” and the like are to be interpreted relative to one another or relative to an axis of elongation, or an axis or center of rotation, as appropriate. Terms concerning attachments, coupling, and the like, such as “connected” and “interconnected,” refer to a relationship wherein structures are secured or attached to one another either directly or indirectly through intervening structures, as well as both movable or rigid attachments or relationships, unless expressly described otherwise. The terms “operatively connected,” “operably connected,” and the like include such attachments, couplings, or connections that allow the pertinent structures to operate as intended by virtue of that relationship. Further, terms concerning communications such as “communicatively coupled” and the like can include wired or wireless connections that allow the pertinent structures to communicate with each other.

Embodiments of the present disclosure relate generally to the control of heating ventilation and cooling (HVAC) systems and, more particularly, to the control of HVAC systems using machine learning processes. For example, a liquid desiccant air-conditioning (LDAC) system may include a conditioner system that uses a conditioning fluid (e.g., a liquid desiccant, water) to condition air. For instance, the conditioner system may receive concentrated conditioning fluid from a storage tank, and may distribute the concentrated conditioning fluid throughout mass transfer elements to dehumidify an incoming stream of air (e.g., outside air as received through an actuated damper and provided by an air fan). As the stream of air is dehumidified, the conditioning fluid dilutes. The conditioner system collects the diluted conditioning fluid, and provides the diluted conditioning fluid back to the storage tank or a separate storage tank. In some instances, the conditioner system distributes working fluid (e.g., water, liquid desiccant) to cool the incoming stream of air. For example, the conditioner system may include a dehumidification stage through which the stream of air is dehumidified, and a cooling stage through which the stream of air is cooled. Further, the conditioner system may direct exhaust air (e.g., air used for cooling equipment) to the outside (e.g., through an actuated damper) and supply air to the space being cooled. In some examples, the conditioner system directs a proportion of the supply air back to serve as exhaust air. The LDAC system may also include a regenerator system that receives the diluted conditioning fluid from the storage tank, and removes water from the diluted conditioning fluid to concentrate the conditioning fluid. The regenerator system provides the concentrated conditioning fluid back to the storage tank.

Further, the LDAC system may include an LDAC control computing device, such as a server (e.g., cloud-based server), that is communicatively coupled to one or more sensors. Sensors may include, for example, flow rate sensors, humidity sensors, temperature sensors, carbon dioxide (CO₂) sensors, carbon monoxide (CO) sensors, and smoke detectors, among others. Flow rate sensors may measure a flow rate of a fluid, such as air, and may generate sensor data characterizing the measured flow rate. Humidity sensors may detect a humidity level (e.g., 0% to 100%) of an environment, and may generate sensor data characterizing the detected humidity level. Furthermore, temperature sensors may detect a temperature of an environment, and may generate sensor data characterizing the detected temperature. CO₂ sensors may detect CO₂ concentrations and generate sensor data characterizing the amount of detected CO₂, while smoke detectors may generate sensor data if a level of smoke is detected. The LDAC control computing device can receive sensor data from one or more of any of these sensors.

The LDAC control computing device may also be communicatively coupled to an LDAC controller. In some instances, the LDAC controller is, or includes, a thermostat. The LDAC controller may be communicatively coupled to the conditioner system and/or regenerator system, and can provide control signals to the conditioner system and/or regenerator system to adjust one or more control settings of the conditioner system and/or regenerator system. Control settings may include, for example, settings for a desired temperature, a desired humidity level, a desired flow rate (e.g., of supply air, exhaust air, return air, working fluid, conditioning fluid), a desired concentration of conditioning fluid, to turn on or off a fan (e.g., supply air fan), or to turn on or off one or more of the conditioner system and regenerator system, among other examples. The LDAC control computing device can transmit to the LDAC controller one or more control signals to adjust any of these or other control settings. In some examples, an LDAC controller includes a thermostat and, in some instances, may additionally or alternatively include one or more sensors, such as any of the sensors described herein.

As described herein, the LDAC control computing device may employ a trained machine learning or artificial intelligence process to determine predicted operational values of the LDAC system. By way of example, to train the machine learning or artificial intelligence process, LDAC control computing device may extract values of adaptively selected features of historical sensor data and historical control setting values for corresponding temporal intervals to generate a training dataset and, in some examples, a validation dataset. The historical sensor data may include historical temperature, humidity, and flow rate sensor values, for example. The historical control setting values may characterize temperatures, humidity levels, and flow rate settings (e.g., as set by a user on a thermostat of the LDAC controller). In some examples, and as described herein, the selected features may include preferred temperatures, preferred humidity levels, and preferred flow rates as obtained from users by, for example, polling the users, such as by polling users via a cellphone application, computer application, or an application on any other suitable electronic device. The LDAC control computing device may perform operations to train the machine learning or artificial intelligence process based on the training dataset. For instance, and as described herein, the LDAC control computing device may train the machine learning or artificial intelligence process until at least one metric is satisfied (e.g., a loss function is below a threshold).

Once the metric is satisfied, the LDAC control computing device may perform operations to validate the machine learning or artificial intelligence process based on the validation dataset. The training is complete if the validation satisfies one or more metrics (e.g., a loss function, such as computed precision values, computed recall values, and computed area under curve (AUC) for receiver operating characteristic (ROC) curves or precision-recall (PR) curves, satisfy a corresponding threshold), for example. Further, and based on an outcome of these training processes, the LDAC control computing device may generate model coefficients, parameters, thresholds, and/or other modelling data that collectively specify the trained machine learning or artificial intelligence process, and may store the generated model coefficients, parameters, thresholds, and/or modelling data within a portion of one or more tangible, non-transitory memories.

Once trained, the LDAC control computing device may apply the trained machine learning or artificial intelligence process to sensor data to generate output data characterizing a predicted operational value of the LDAC system during a future temporal interval (e.g., an hour interval a day, week, or month later). For example, the LDAC control computing device may receive sensor data from one or more sensors, and may apply the trained machine learning or artificial intelligence process to the sensor data to generate the output data characterizing one or more predicted operational values. In some examples, the LDAC control computing device applies the trained machine learning or artificial intelligence process to the sensor data and to load data characterizing building loads (e.g., room loads), such as thermal loads, of a corresponding building. The predicted operational value may be, for instance, a temperature (e.g., room temperature), a humidity level, or a gas concentration (e.g., CO₂ concentration) predicted for the future temporal interval. In some examples, the LDAC control computing device 102 applies the trained machine learning or artificial intelligence process to input data characterizing potential future operational control settings of the LDAC system that creates a certain supply air flow and/or condition to generate output data characterizing a room temperature, humidity, and/or carbon dioxide concentration. As such, the LDAC system may predict a rooms reaction to an LDAC setting based on a predicted thermal load (sensible and/or latent) of a building. The trained machine learning or artificial intelligence process may include an ensemble or decision-tree process, such as a gradient-boosted decision-tree process (e.g., the XGBoost model), a clustering process, an unsupervised learning process (e.g., a k-means algorithm, a mixture model, a hierarchical clustering algorithm, etc.), a semi-supervised learning process, a supervised learning process, a statistical process (e.g., a multinomial logistic regression model, etc.), a random decision forest, a neural network such as an artificial neural network or a deep neural network, or an association-rule process (e.g., an Apriori algorithm, an Eclat algorithm, or an FP-growth algorithm).

Based on the generated output data, the LDAC control computing device may adjust one or more of the control settings of the LDAC system. For instance, and based on the output data, the LDAC control computing device may transmit a signal to the LDAC controller to adjust a conditioning fluid flow rate of the conditioning system to change a humidity level of the supply air (e.g., an increase in the conditioning fluid flow rate tends to decrease the humidity level of the supply air, and a decrease in the conditioning fluid flow rate tends to increase the humidity level of the supply air). As another example, and based on the output data, the LDAC control computing device may transmit a signal to the LDAC controller to adjust a concentration of the conditioning fluid generated by the regenerator system to change the humidity level of the supply air (e.g., an increase in the concentration of the conditioning fluid tends to decrease the humidity level of the supply air, and a decrease in the concentration of the conditioning fluid tends to increase the humidity level of the supply air).

As yet another example, and based on the output data, the LDAC control computing device may transmit a signal to the LDAC controller to vary an exhaust air ratio (e.g., the ratio of exhaust air to supply air) to change a temperature of the supply air. In some examples, and based on the output data, the LDAC control computing device may transmit a signal to the LDAC controller to adjust an exhaust air flow rate of the conditioner system to change a temperature of the supply air (e.g., an increase in the exhaust air flow rate tends to decrease the temperature of the supply air, and a decrease in the exhaust air flow rate tends to increase the temperature of the supply air). For instance, the LDAC controller may transmit a signal to adjust a fan speed of the conditioner system. In some examples, the LDAC controller receives sensor data indicating a flow of the exhaust air, and may determine whether an exhaust flow rate has been reached based on the sensor data. In some examples, the LDAC controller determines the a flow of fluid based on receiving measurements for two or more other flows of the fluid. For example, the LDAC controller may receive sensor data indicating a flow of outside air, a flow of return air, and a flow of exhaust air. The LDAC controller may determine a flow of supply air based on the difference between the sum of the flows of outside air and return air, minus the flow of exhaust air. In some examples, and based on the output data, the LDAC control computing device may transmit a signal to the LDAC controller to adjust the flow of supply air based on the determined amount of supply air. In any of the above examples, the relative amounts of air flow (e.g., supply air, exhaust air, etc.) may be controlled and/or modified using one or more dampers.

The LDAC control computing device may adjust the one or more of the control settings of the LDAC system at a point in time prior to the future temporal interval so as to reach a preferred operational value during the future temporal interval. For example, the generated output data may indicate a predicted temperature of 90 degrees for a room for a future temporal interval that begins in four hours (e.g., based on predicted load data for a building, or in order to minimize energy consumption, or in order to minimize energy costs, or in order to create a desired load shape to help match energy supply from a utility, or to minimize greenhouse gases). As such, and based on a desired temperature of 75 degrees during the future temporal interval, the LDAC control computing device may, in two hours, cause the LDAC controller to increase the exhaust air ratio so that the temperature is at least 75 degrees during (e.g., at the start of) the future temporal interval. Similarly, the generated output data may indicate a predicted humidity level of 75% for the room during the future temporal interval. Pre-dehumidifying the air ahead of an expected humidity load, such that that energy storage desiccant lasts longer during the high humidity load event, can increase the extent of energy storage and peak load reduction. As such, and based on a desired humidity level for the room of 50% during the future temporal interval, the LDAC control computing device may, in two hours, cause the LDAC controller to increase the conditioning fluid flow rate to lower the humidity level so that it reaches the 50% by the future temporal interval. Indeed, given the prediction of a room's response to the LDAC, the rate at which to treat the load of a building can be determined. For instance, a common problem with conventional AC systems is that they operate with little or no variation in supply air conditions regardless of what the actual cooling load might be in the building. This may result in overcooling of the building when the system turns on, creating uncomfortable or undesirable room conditions. In contrast, the LDAC control computing device can match the LDAC supply air conditions to match a cooling load of the building, thereby creating a smoother transition between two different conditions, and/or creating more constant room conditions (e.g., when the room settings are to remain constant).

The desired temperature may, in some examples, be stored in a memory device as a preferred temperature for the future temporal interval. For example, the memory device may store a conditioning schedule that identifies preferred temperatures and, in some examples, humidity levels, for corresponding temporal intervals for each day of the week. For example, the conditioning schedule may identify a preferred temperature and a preferred humidity level for each four hour interval of each day of the week. In some examples, the temporal intervals vary. For example, the conditioning schedule may include a first temporal interval of two hours, a second temporal interval of eight hours, and a third temporal interval of fourteen hours for a given day.

In some examples, the LDAC control computing device allows a user to define the temporal intervals (e.g., day, start time, end time), and select the preferred temperature and humidity level for each temporal interval. The LDAC control computing device may then generate and/or update the conditioning schedule, and store the conditioning schedule in the memory device. The LDAC control computing device may then apply the trained machine learning or artificial intelligence process to sensor data and/or building load data to assure that the preferred temperature and/or humidity level is reached during the temporal intervals. In some instances, the LDAC control computing device receives polling information from one or more users, where the polling information identifies preferred temperatures and/or humidity levels of the users. Based on the polling information, the LDAC control computing device may generate and/or update the conditioning schedule in the memory device. For example, the LDAC control computing device may average the preferred temperatures, and may update the conditioning schedule with the average temperature (e.g., for a corresponding temporal interval). Similarly, the LDAC control computing device may average the preferred humidity levels, and may update the conditioning schedule with the average humidity level (e.g., for a corresponding temporal interval). Furthermore, these set points (e.g., conditioning schedule) could be subjective in nature, such as when polling users with questions such as “I'm comfortable,” “I'm cold,” “I'm muggy,” etc. Based on these polling questions, the LDAC control computing device can determine temperature and humidity targets which are most likely to satisfy the greatest number of occupants. The system can then assess its success by either noticing a change in frequency of complaints, or else pushing the user for new information via a prompt such as “We have adjusted the air conditioning operation to make you more comfortable. Are you comfortable now?” and processing responses to these additional polling questions.

In some examples, the LDAC control computing device determines the conditioning schedule based on historical settings of the LDAC system. For instance, the LDAC computing system may determine a statistical measure, such as an average, of LDAC controller settings provided by a user (e.g., a temperature and/or humidity setting on a thermostat) over the same temporal interval (e.g., timeslot) over a number of days (e.g., three days, a week, a month, three months, a year, per season, etc.). For example, the LDAC control computing device may determine an average temperature setting, and an average humidity level setting, during corresponding time periods over the number of days. Based on the determined average temperature settings and humidity level settings, the LDAC control computing device may generate the conditioning schedule.

In some examples, the LDAC control computing device determines when to adjust the control settings, and by how much to adjust the control settings, based on temperature tables and/or humidity tables stored in the memory device. For instance, a temperature table may indicate an amount of time needed to increase, or decrease, the temperature of a volume of space by a corresponding amount for various water flow rates and/or exhaust air rates. Similarly, a humidity table may indicate an amount of time needed to increase, or decrease, the humidity level of a volume of space by a corresponding amount for various conditioning fluid flow rates or concentrations. Based on the output data characterizing a predicted operational value, such as temperature or humidity level, of the LDAC system during the future temporal interval, and the temperature table and/or humidity table, the LDAC control computing device may determine when, and by what amount, to adjust the control setting.

In some instances, the LDAC control computing device determines the temperature table and/or the humidity table based on historical sensor readings and historical settings of the LDAC system. For example, the LDAC control computing device may determine a statistical measure, such as an average, based on the historical sensor readings and the historical settings. For instance, the LDAC control computing device may determine how long it took the LDAC system to reach a particular temperature or humidity level given a starting temperature or humidity level, a final temperature or humidity level, a starting value of a control setting (e.g., initial water flow rate) and a final value of a control setting (e.g., adjusted water flow rate). In addition, such a determination may further consider the historical load profile at a given start time and day of the week for a given period of time. Thus, a desired temperature or humidity change may take more time during peak building occupancy, peak sun exposure, or other building conditions (e.g., open windows or doors) than at a period of lower building occupancy or sun exposure. Moreover, analyzing this behavior of the system can be used to uncover instantaneous building thermal and moisture loads, and could be stored and analyzed to predict future loads. Furthermore, by comparing expected loads to instantaneous loads, events may be inferred that affect the operation of the system. As an example, based on comparing expected loads to instantaneous loads, the LDAC control computing device may determine that all windows were left open, and may provide an indication to turn off the air conditioner.

In some instances, the LDAC control computing device may apply a second trained machine learning process or artificial intelligence process to the current sensor readings and current control settings to determine the temperature table and/or the humidity table (e.g., table values). The second trained machine learning or artificial intelligence process may include an ensemble or decision-tree process, such as a gradient-boosted decision-tree process (e.g., the XGBoost model), a clustering process, an unsupervised learning process (e.g., a k-means algorithm, a mixture model, a hierarchical clustering algorithm, etc.), a semi-supervised learning process, a supervised learning process, a statistical process (e.g., a multinomial logistic regression model, etc.), a random decision forest, a neural network such as an artificial neural network or a deep neural network, or an association-rule process (e.g., an Apriori algorithm, an Eclat algorithm, or an FP-growth algorithm). The LDAC control computing device may train this second machine learning process or artificial intelligence process based on a training dataset, and in some examples a validation data set, as described herein. Each of these training and validation datasets include features of historical sensor readings and historical control settings. In some examples, because the LDAC system can alter the supply air humidity and temperature independently, the LDAC system executes an experimental process whereby each of temperature and humidity are varied independent of each other (e.g., supply air temperature is reduced significantly without reducing its water content and vice-versa), and room conditions based on the changes are recorded to generate training data. As such, the training data may characterize a separation of the effects of each change.

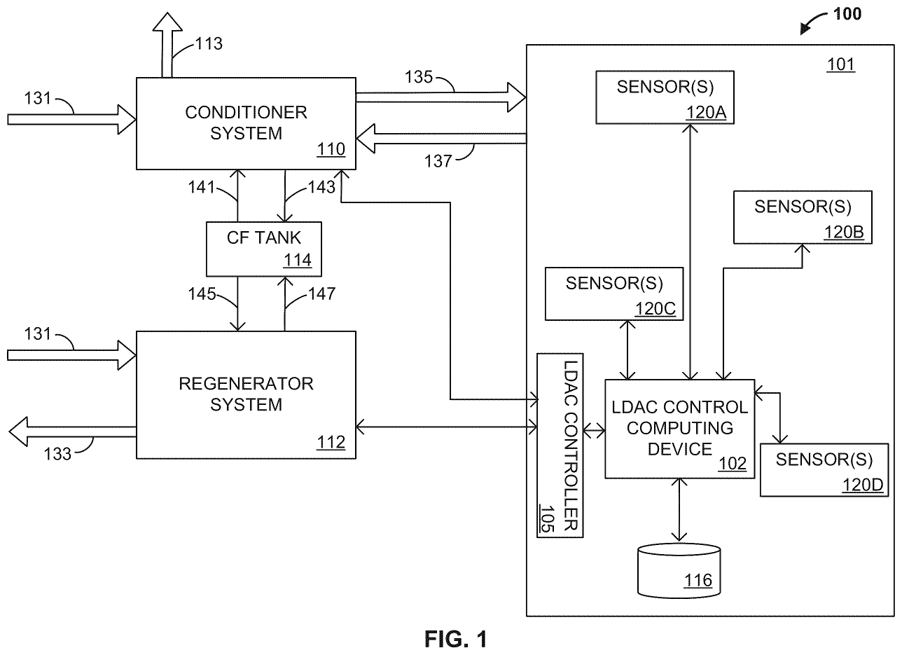

Referring to the drawings, FIG. 1 illustrates an example of an LDAC system 100 that includes a conditioner system 110, a conditioning fluid (CF) tank 114, and a regenerator system 112 that operate to provide a stream of supply air 135 to a building 101. For example, CF tank 114 may store a conditioning fluid, such as liquid desiccant. Conditioner system 110 may receive concentrated conditioning fluid 141 from the CF tank 114, and may use the concentrated conditioning fluid 141 to dehumidify a stream of outside air 131 (e.g., during a dehumidification stage). The conditioner system 110 may collect diluted conditioning fluid (e.g., conditioning fluid that has been used to dehumidify the stream of outside air 131), and may provide the diluted conditioning fluid 143 back to the CF tank 114.

Further, the conditioner system 110 may, in some examples, cool the stream of outside air 131 during a cooling stage (e.g., using a working fluid, such as water). After passing through a dehumidification stage and, in some examples, a cooling stage, the stream of outside air 131 is provided as a stream of supply air 135 to building 101. In some examples, conditioner system receives return air 137 from the building 101, and mixes the return air 137 with the stream of outside air 131 to form mixed air before dehumidifying and/or cooling the mixed air to provide the stream of supply air 135. In some instances, a portion of the mixed air (i.e., return air 137 mixed with outside air 131) is used to cool the components of the conditioner system 110. In some instances, a portion of the outside air 131 is used to cool the components of the conditioner system 110, and may proceed out the conditioner system 110 as a stream of exhaust air 113 to an outside environment.

Regenerator system 112 receives diluted conditioning fluid 145 from the CF tank 114, and concentrates the diluted conditioning fluid 145 to generate concentrated conditioning fluid 147 that is provided back to the CF tank 114. Regenerator system 112 may receive a stream of outside air 131 to cool components, and may provide a stream of exhaust air 133 back to the outside environment.

LDAC system 100 also includes an LDAC control computing device 102 communicatively coupled to a database 116, to an LDAC controller 105, and to a plurality of sensors 120A, 120B, 120C, 120D. Each of the plurality of sensors 120A, 120B, 120C, 120D may be, for example, a flow rate sensor, a humidity sensor, a temperature sensor, a CO₂ sensor, an occupancy sensor, or a smoke detector, among other examples. As illustrated, each of the plurality of sensors 120A, 120B, 120C, 120D may be located throughout the building 101. In some examples, a sensor 120A, 120B, 120C, 120D may be positioned near, or within, an inlet duct or outlet duct that passes one or more of the supply air 135 or the return air 137. In some examples, one or more sensors 120A, 120B, 120C, 120D may be positioned at, near, or within inlets of ventilation air for the building, and/or at, near, or within outlets for building exhaust air. In some examples, one or more sensors 120A, 120B, 120C, 120D, such as one or more of a temperature sensor and a humidity sensor, may be placed in each room of a multi-room building. For instance, the sensors 120A, 120B, 120C, 120D may be positioned in each room near a doorway that leads out of the room. In some instances, a sensor 120A, 120B, 120C, 120D may be positioned within the conditioner 110 or regenerator 112 to measure, for instance, exhaust air flow, return air flow, supply air flow, conditioning fluid flow, etc. LDAC control computing device 102 can receive sensor data from each of the plurality of sensors 120A, 120B, 120C, 120D.

LDAC controller 105 is communicatively coupled to conditioner system 110 and, in some examples, regenerator system 112. LDAC controller 105 may include circuitry, such as one or more processors and a transceiver, that allows LDAC controller 105 to send signals to conditioner system 110 and/or regenerator system 112 to adjust control settings of the conditioner system 110 and/or regenerator system 112. For example, LDAC controller 105 can transmit a signal to conditioner system 110 that causes conditioner system 110 to adjust a conditioning fluid flow rate of the conditioning system. As another example, LDAC controller 105 can transmit a signal to conditioner system 110 that causes conditioner system 110 to adjust a water flow rate of the working fluid flowing through the conditioner system 110, or to adjust an exhaust air flow rate of the conditioner system. LDAC controller 105 can also transmit a signal to regenerator system 112 that causes regenerator system 112 to adjust a concentration of the conditioning fluid. In some examples, LDAC controller 105 is, or includes, one or more thermostats, for instance.

Further, and as described herein, LDAC control computing device 102 can transmit a signal to LDAC controller 105 to cause the LDAC controller to adjust any of the control settings of the conditioner system 110 and/or regenerator system 112. For instance, LDAC control computing device 102 may receive sensor data from any of the sensors 120A, 120B, 120C, 120D and, based on the sensor data, transmit a signal to the LDAC controller 105 to adjust one or more of the control settings. By way of example, LDAC control computing device 102 may establish any of the trained machine learning or artificial intelligence processes described herein. Further, LDAC control computing device 102 may receive sensor data from one or more of the sensors 120A, 120B, 120C, 120D, and may generate features based on the received sensor data. LDAC control computing device 102 may apply the established trained machine learning or artificial intelligence processes to the generated features to generate output data characterizing a predicted operational value of the LDAC system 100 during a future temporal interval. As described herein, each predicted operational value may be, for example, a temperature or a humidity level predicted for the future temporal interval. Based on the generated output data, the LDAC control computing device 102 may transmit a signal to the LDAC controller 105 to adjust one or more of the control settings.

As described herein, the LDAC control computing device 102 may transmit the signal to the LDAC controller 105 to adjust the control settings at a point in time prior to the future temporal interval. For example, the LDAC control computing device 102 may transmit the signal to the LDAC controller 105 so as to reach a preferred operational value (e.g., a preferred temperature and/or humidity level) during the future temporal interval.

In some examples, the desired operational values are stored in database 116. For example, database 116 may store a conditioning schedule that identifies preferred temperatures and, in some examples, humidity levels, for corresponding temporal intervals for each day of the week. In some examples, a user can provide input to the LDAC control computing device 102 to add, remove, and/or adjust the desired operational values of the conditioning schedule stored in database 116. The LDAC control computing device 102 can also store individual user data and profiles. In some examples, database 116 stores opinion data that may include, for instance, polling information characterizing preferred operational values. LDAC control computing device 102 may adjust the conditioning schedule within database 116 based on the opinion data.

In some examples, LDAC control computing device 102 determines the desired operational values for the conditioning schedule based on historical settings of the LDAC system 100. For instance, the LDAC control computing device 102 may determine a statistical measure of LDAC controller settings provided by a user (e.g., a temperature and/or humidity setting on a thermostat) over a recurring temporal interval over a number of days. LDAC control computing device 102 may update the conditioning schedule based on the statistical measure.

In some examples, the LDAC control computing device 102 determines when to adjust the control settings, and by how much to adjust the control settings, based on temperature tables and/or humidity tables stored in database 116. As described herein, the temperature table may indicate an amount of time needed to increase, or decrease, the temperature of a volume of space by a corresponding amount for various water flow rates and/or exhaust air rates, while a humidity table may indicate an amount of time needed to increase, or decrease, the humidity level of a volume of space by a corresponding amount for various conditioning fluid flow rates or concentrations. Based on the output data generated by the established machine learning process or artificial intelligence process, as well the temperature and/or humidity tables, the LDAC control computing device 102 may determine when, and by what amount, to adjust a control setting to achieve the preferred operational value during the future temporal interval.

In some instances, the LDAC control computing device 102 may apply a second trained machine learning process or artificial intelligence process to sensor data received from one or more of the sensors 120A, 120B, 120C, 120D and to control settings (e.g., identifying current settings) to determine values of the temperature table and/or the humidity table, and may store the values within the temperature table and/or the humidity table of database 116.

In some examples, the LDAC control computing device 102 provides a warning indication based on the output data characterizing the predicted operational value of the LDAC system 100. For instance, if the output data indicates a predicted operational value, such as a CO₂ sensor level, that is beyond (e.g., above) a threshold amount, the LDAC control computing device 102 may generate and display a warning message. In some examples, the LDAC control computing device 102 may generate and transmit a communication advising of the warning (e.g., an e-mail, an SMS message, etc.). The warning indication may identify the sensor and the corresponding predicted operational value. In some examples, the LDAC control computing device 102 may transmit a signal to the LDAC controller 105 to adjust one or more control settings of the LDAC system 100, such as to adjust (e.g., decrease) the amount of return air 137 mixed with the stream of outside air 131. In this manner, the return air 137 may be provided to the outside environment with the stream of exhaust air 113 rather than being recycled back to the building 101. In some instances, the warning can indicate a predictive-maintenance event (e.g., maintenance required to the conditioner system 110 and/or regenerator system 112), or a building 101 related event (e.g., open window, over-occupied, etc.). In some examples, the LDAC control computing device 102 determines whether a material change has occurred in the building 101 or in the LDAC system 100, and generate the warning based on the determination. For instance, the LDAC control computing device 102 may compare the predicted operational value of the LDAC system 100 to a corresponding actual value (e.g., current temperature, humidity level, CO₂ level, etc.) to determine whether an error condition exists (e.g., a difference between the predicted operational value and the actual operational value is beyond a threshold). Further, and based on a determined error condition, the LDAC system 100 can determine a most likely reason for the error condition, such as an open door, an open window, that LDAC system 100 maintenance is required, or some other condition that may cause the error condition.

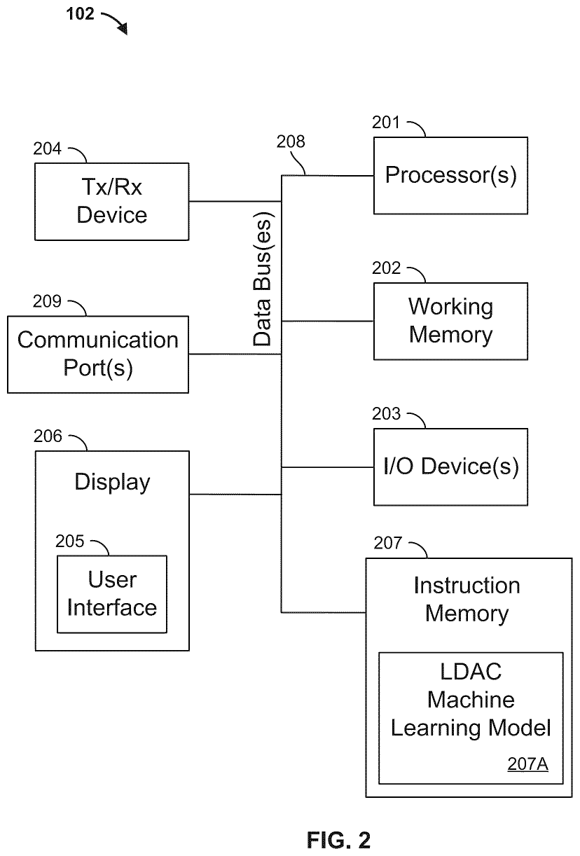

FIG. 2 illustrates an exemplary LDAC control computing device 102 of the LDAC system 100 of FIG. 1. LDAC control computing device 102 can include one or more processors 201, working memory 202, one or more input/output devices 203, instruction memory 207, a transceiver 204, one or more communication ports 209, and a display 206, all operatively coupled to one or more data buses 208. Data buses 208 allow for communication among the various devices. Data buses 208 can include wired, or wireless, communication channels.

Processors 201 can include one or more distinct processors, each having one or more cores. Each of the distinct processors can have the same or different structure. Processors 201 can include one or more central processing units (CPUs), one or more graphics processing units (GPUs), application specific integrated circuits (ASICs), digital signal processors (DSPs), and the like. Processors 201 can be configured to perform a certain function or operation by executing code, stored on instruction memory 207, embodying the function or operation. For example, processors 201 can be configured to perform one or more of any function, method, or operation disclosed herein.

Instruction memory 207 can store instructions that can be accessed (e.g., read) and executed by processors 201. For example, instruction memory 207 can be a non-transitory, computer-readable storage medium such as a read-only memory (ROM), an electrically erasable programmable read-only memory (EEPROM), flash memory, a removable disk, CD-ROM, any non-volatile memory, or any other suitable memory. In this example instruction memory 207 includes LDAC machine learning model data 207A that includes instructions characterizing models of any of the trained machine learning or artificial intelligence processes described herein. For example, one or more processors 201 may obtain LDAC machine learning model data 207A from instruction memory 207, and may execute LDAC machine learning model data 207A to establish any of the trained machine learning or artificial intelligence processes described herein.

Further, processors 201 can store data to, and read data from, working memory 202. For example, processors 201 can store a working set of instructions to working memory 202, such as instructions loaded from instruction memory 207. Processors 201 can also use working memory 202 to store dynamic data created during the operation of LDAC control computing device 102. Working memory 202 can be a random access memory (RAM) such as a static random access memory (SRAM) or dynamic random access memory (DRAM), or any other suitable memory.

Input-output devices 203 can include any suitable device that allows for data input or output. For example, input-output devices 203 can include one or more of a keyboard, a touchpad, a mouse, a stylus, a touchscreen, a physical button, a speaker, a microphone, or any other suitable input or output device. Input-output device 203 may allow a user to provide input selecting or characterizing preferred operational values as described herein, for instance.

Communication port(s) 209 can include, for example, a serial port such as a universal asynchronous receiver/transmitter (UART) connection, a Universal Serial Bus (USB) connection, or any other suitable communication port or connection. In some examples, communication port(s) 209 allows for the programming of executable instructions in instruction memory 207. In some examples, communication port(s) 209 allow for the transfer (e.g., uploading or downloading) of data, such as opinion data (e.g., polling information).

Display 206 can display user interface 205. User interfaces 205 can enable user interaction with the LDAC control computing device 102. For example, user interface 205 can be a user interface for an application that allows a user to enter preferred operational values to update a conditioning schedule stored in database 116, for example. In some examples, a user can interact with user interface 205 by engaging input-output devices 203. In some examples, display 206 can be a touchscreen, where user interface 205 is displayed on the touchscreen.

Transceiver 204 allows for communication with a network, such as a wireless network established between LDAC control computing device 102 and LDAC controller 105. For example, transceiver 204 may connect to a WiFi, Bluetooth, cellular, or any other suitable wireless network, and may send signals (e.g., data) to, and receive signals from, LDAC controller 105 over the wireless network. In some instances, transceiver 204 may, additionally or alternatively, communicate with one or more sensors, such as sensors 120A, 120B, 120C, 120D, over the wireless network. Processor(s) 201 is operable to receive data from, or send data to, the wireless network via transceiver 204.

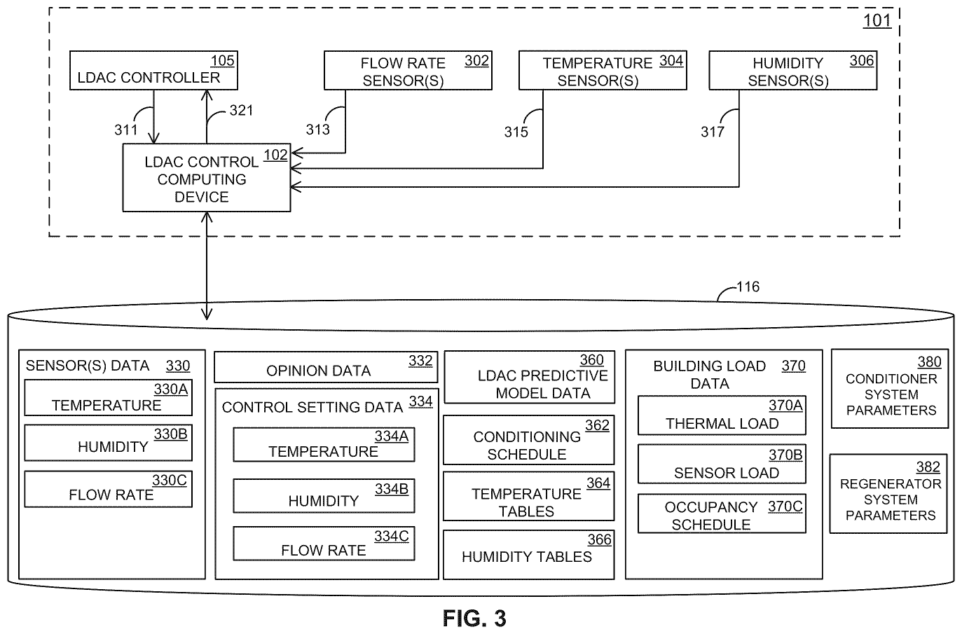

FIG. 3 illustrates exemplary portions of the LDAC system 100 of FIG. 1. In this example, LDAC control computing device 102 can receive sensor data from various sensors. For instance, LDAC control computing device 102 can receive flow rate data 313 from one or more flow rate sensors 302, temperature data 315 from one or more temperature sensors 304, and humidity data 317 from one or more humidity sensors 306. LDAC control computing device 102 may parse the flow rate data 313, temperature data 315, and humidity data 317 to generate elements of sensor data 330, and may store the elements of sensor data 330 within database 116. The sensor data 330 may include temperature values 330A, humidity values 330B, and flow rate values 330C.

Database 116 may also store LDAC predictive model data 360, which may include model coefficients, parameters, thresholds, and/or other modelling data that collectively specify one or more of the trained machine learning or artificial intelligence processes described herein. For example, LDAC control computing device 102 may obtain LDAC predictive model data 360 from database 116, and may establish any of the trained machine learning or artificial intelligence processes described herein based on the LDAC predictive model data 360.

Database 116 may also store conditioning schedule 362, temperature tables 364, and humidity tables 366. As described herein, the conditioning schedule 362 stores desired operational values during corresponding temporal intervals, such as preferred temperatures and humidity levels. Further, the temperature tables 364 store values indicating an amount of time needed to increase, or decrease, the temperature of a volume of space by a corresponding amount (e.g., for various water flow rates and/or exhaust air rates), while the humidity tables 366 store values indicating an amount of time needed to increase, or decrease, the humidity level of a volume of space by a corresponding amount (e.g., for various conditioning fluid flow rates or concentrations).

Database 116 may further store opinion data 332, which may include preferred operational values, such as preferred temperatures and/or humidity levels, during corresponding temporal intervals. For example, the opinion data 332 may include statistical measures of polling information received from various users (e.g., inhabitants of a building). In some instances, the opinion data 332 includes preferred operational values from one or more users for each of multiple rooms of a building, such as for rooms of building 101.

Furthermore, database 116 may store control setting data 334 that includes values (e.g., current and/or historical values) for one or more control settings of the conditioner system 110 and the regenerator system 112. For instance, the control setting data 334 may include temperature settings 334A (e.g., a current temperature setting and historical temperature settings), humidity settings 334B (e.g., a current humidity level setting and historical humidity level settings), and flow rate settings 334C (e.g., a current flow rate setting and historical flow rate settings) of the LDAC system 100. The LDAC control computing device may receive a control setting signal 311 (e.g., upon request) characterizing one or more current control settings of the conditioner system 110 and/or the regenerator system 112.

Database 116 may also store building load data 370 that characterizes load data for a building, such as building 101. For instance, building load data 370 may include one or more of thermal load 370A, sensor load 370B, and occupancy schedule 370C. Thermal load 370A may characterize one or more thermal loads of a building, such as a thermal load of a room of building 101. Sensor load 370B may characterize a load of a sensor, such a load of a CO₂ sensor located in a room of building 101. Occupancy schedule 370C may characterize an expected occupancy of a building, or of a room of a building, during a particular time interval. In some instances, the LDAC control computing device 102 may apply the trained machine learning or artificial intelligence process described herein, such as the trained machine learning or artificial intelligence process characterized by the LDAC predictive model data 360, to portions of store building load data 370 to generate the output data characterizing one or more predicted operational values.

Database 116 may also include conditioner system parameters 380 and regenerator system parameters 382. Conditioner system parameters 380 may include operational and/or performance parameters of a corresponding conditioner system, such as conditioner system 110. Regenerator system parameters 382 may include operational and/or performance parameters of a corresponding regenerator system such as regenerator system 112.

LDAC control computing device 102 may generate features based on sensor data 330, and may apply the established trained machine learning or artificial intelligence processes to the generated features to generate output data characterizing a predicted operational value of the LDAC system during a future temporal interval. As described herein, each predicted operational value may be, for example, a temperature or a humidity level predicted for the future temporal interval. Based on the generated output data, the LDAC control computing device 102 may transmit an adjust signal 321 to the LDAC controller 105 to adjust one or more of the control settings. For example, the LDAC control computing device 102 may transmit the adjust signal 321 to the LDAC controller 105 so as to reach a desired operational value (e.g., as indicated by the conditioning schedule 362) during the future temporal interval.

In some examples, the LDAC control computing device 102 determines when to adjust the control settings, and by how much to adjust the control settings, based on temperature tables 364 and/or humidity tables 366 stored in database 116. For instance, LDAC control computing device 102 may locate time and adjustment entries within the temperature tables 364 and/or humidity tables 366 corresponding to the predicted operational value (e.g., a predicted temperature) generated by the trained machine learning or artificial intelligence process and a corresponding current operational value (e.g., a current temperature) for a volume of space, such as a volume of a room of building 101, or the volume of space of the building 101. The time entry may indicate an amount of time needed to adjust from the current operational value to the predicted operational value, and the adjustment entry may indicate an adjustment amount needed for the adjustment. LDAC control computing device 102 may transmit the adjust signal 321 to the LDAC controller 105 at the determined amount of time before the future temporal interval to adjust the corresponding control setting by the adjustment amount.

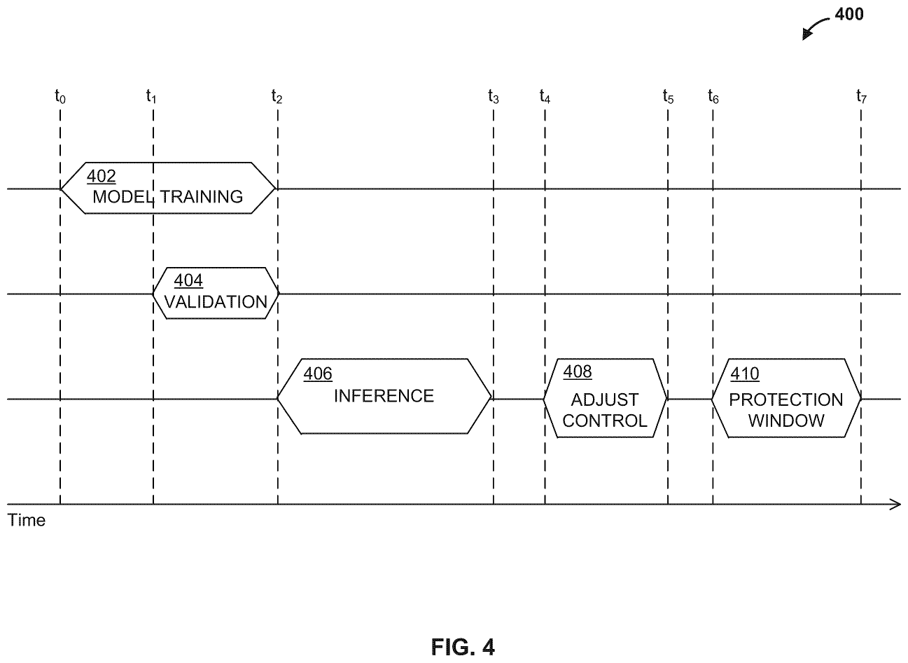

FIG. 4 illustrates an exemplary timing diagram 400 for training any of the machine learning or artificial intelligence processes described herein, and for applying the trained machine learning or artificial intelligence processes to generated features to determine a predicted operational value, and to adjusting a control setting to reach a desired operational value during a future temporal interval.

For example, as illustrated, LDAC control computing device 102 may train a machine learning or artificial intelligence process during the model training window 402. For instance, and as described herein, LDAC control computing device 102 may extract values of adaptively selected features of historical sensor data, such as values of sensor data 330, and historical control setting data, such as values of control setting data 334, for corresponding temporal intervals to generate a training dataset. In some examples, the LDAC control computing device 102 generates the training dataset based on the historical sensor data 330, the historical control setting data 334, and one or more operational or performance parameters of conditioner system 110 and regenerator system 112. Further, in some examples, LDAC control computing device 102, similarly generates a validation dataset. The validation dataset may be based on historical sensor data and historical control setting data corresponding to a different, and non-overlapping, temporal interval than the historical sensor data and historical control setting data from which the training dataset is based. Further, and during the model training window 402, LDAC control computing device may perform operations to train the machine learning or artificial intelligence process based on the training dataset. For instance, and as described herein, the LDAC control computing device 102 may train the machine learning or artificial intelligence process until at least one metric is satisfied (e.g., a loss function is below a threshold).

Once the at least one metric is satisfied, the LDAC control computing device 102 may perform operations to validate the initially trained machine learning or artificial intelligence process during the validation window 404. For example, the LDAC control computing device 102 may determine one or more metrics based on the output data generated from applying the initially trained machine learning or artificial intelligence process to the validation dataset (e.g., based on comparing expected data to the output data, such as during supervised learning), and may determine that the initially trained machine learning or artificial intelligence process is validated once the one or more metrics satisfy corresponding thresholds.

Once validated, the LDAC control computing device 102 may now apply the now trained machine learning or artificial intelligence process to received sensor data (e.g., sensor data received in real-time) during an inference window 406 to generate output data characterizing one or more predicted operational values during a future temporal period, such as during prediction window 410. Further, may determine a time of adjustment and amount of adjustment to a control setting of LDAC system 100 based on the predicted operational values and, for instance, a conditioning schedule such as conditioning schedule 362 characterizing desired operational values, and a temperature table, such as temperature table 364, and/or a humidity table, such as a humidity table 366, as described herein.

The LDAC control computing device 102 may then transmit an adjust signal, such as adjust signal 321, to the LDAC controller 105 to adjust the corresponding control setting during the determine time of adjustment, such as during adjust control window 408. In this example, the amount of time needed for adjustment to reach a desired operational condition from the predicted operational condition is shown between t4, when the adjust signal is transmitted, to time t6, when the prediction window 410 begins.

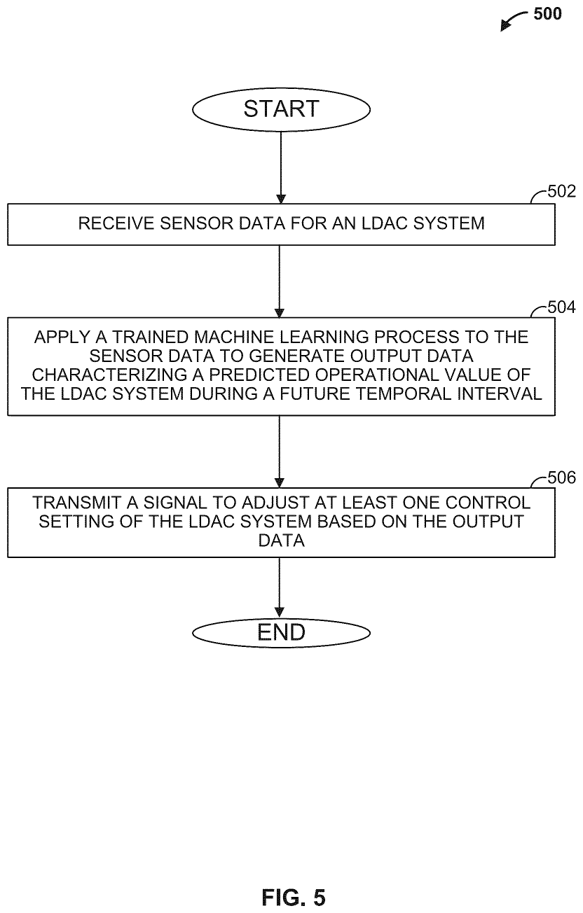

FIG. 5 illustrates an exemplary process 500 for adjusting a control setting of an HVAC system, such as the LDAC system 100 of FIG. 1. The exemplary process 500 may be carried out by one or more computing devices, such as the LDAC control computing device 102.

Beginning at block 502, sensor data is received for an LDAC system. For instance, the LDAC control computing device 102 may receive sensor data from one or more sensors 120A, 120B, 120C, 120D.

At block 504, a trained machine learning process is applied to the sensor data to generate output data characterizing a predicted operational value of the LDAC system during a future temporal interval. For example, and as described herein, LDAC control computing device 102 may generate features based on the received sensor data. LDAC control computing device 102 may apply an established trained machine learning or artificial intelligence process, such as one characterized by LDAC predictive model data 360, to the generated features to generate output data characterizing a predicted operational value of the LDAC system 100 during a future temporal interval. As described herein, each predicted operational value may be, for example, a temperature or a humidity level predicted for the future temporal interval, such as during the prediction window 410.

Further, at block 506, a signal is transmitted to adjust at least one control setting of the LDAC system based on the output data. For instance, as described herein, LDAC control computing device 102 may determine a time of adjustment, and an amount of adjustment, of the at least one control setting based on the generated output data, the conditioning schedule 362, and entries of one or more of a temperature table 364 and a humidity table 366. Further, based on the time of adjustment, the LDAC control computing device 102 may transmit an adjust signal 321 to the LDAC controller 105 during a time window, such as during adjust control window 408, to adjust the at least one control setting of the LDAC system 100.

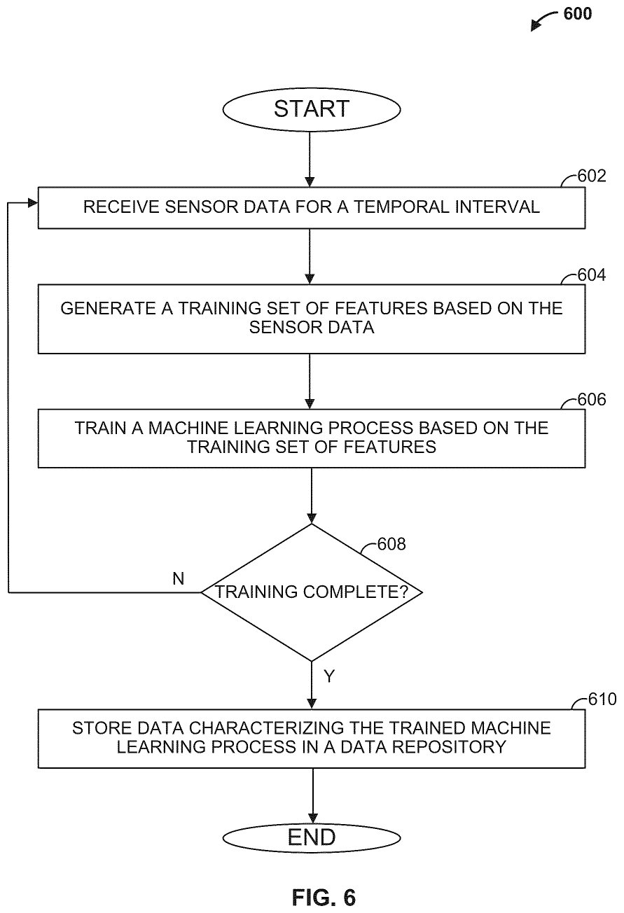

FIG. 6 illustrates an exemplary process 600 for training a machine learning process. The exemplary process 600 may be carried out by one or more computing devices, such as the LDAC control computing device 102.

Beginning at block 602, sensor data is received for a temporal interval. For example, and as described herein, LDAC control computing device 102 may obtain historical sensor data 330 and historical control setting data 334 from database 116. Further, at block 604, a training set of features is generated based on the sensor data. For example, LDAC control computing device 102 may generate a training dataset based on historical sensor data 330 and historical control setting data 334 corresponding to a first temporal interval (e.g., a three month temporal interval, a six month temporal interval, a year, etc.). In some examples, the training set of features is generated based on the historical sensor data 330, the historical control setting data 334, and one or more operational or performance parameters of conditioner system 110 and regenerator system 112, such as conditioner system parameters 380 and regenerator system parameters 382.

Proceeding to block 606, a machine learning process is trained based on the training set of features. For example, LDAC control computing device 102 may input elements of the training dataset to the machine learning process to generate output data. The training may be performed, for example, during a corresponding time window, such as during model training window 402.

At block 608, a determination is made as to whether the training is complete. For example, based on the output data generated during the training performed at block 606, LDAC control computing device 102 may compute one or more metrics, and determine whether the one or more metrics satisfy (e.g., are below) a corresponding threshold. If the one or more metrics satisfy their corresponding thresholds, the training is complete. Otherwise, if the one or more metrics are not satisfied, the training is not complete. If training is not complete, the process proceeds back to block 602 to receive additional sensor data to continue with training. Otherwise, if training is complete, the method proceeds to block 610.

At block 610, data characterizing the trained machine learning process is stored in a data repository. For example, LDAC control computing device 102 may generate model coefficients, parameters, thresholds, and/or other modelling data that collectively specify the trained machine learning process, and may store the generated model coefficients, parameters, thresholds, and/or modelling data within database 116 as LDAC predictive model data 360.

As such, at least some embodiments employ machine learning based processes for predicting environmental conditions at a future point in time, such as temperature and humidity levels, and proactively adjust control settings of an HVAC system to meet desired environment conditions at the future point in time. For example, and as described herein, a computing device may receive sensor data from various sensors, including, for instance, a temperature sensor, a humidity sensor, and an air flow rate sensor. The computing device may generate features based on the sensor data, and may apply a trained machine learning process to the features to generate output data that characterizes a predicted environmental condition, such as a predicted temperature or humidity level. Further, and based on the output data, the computing device performs operations to cause an adjustment to an HVAC system to meet a desired environmental condition at that future point in time. As described herein, the machine learning process may be trained based on features generated from historical sensor data and historical control settings of the HVAC system.

The various embodiments described above are provided by way of illustration only and should not be construed to limit the claims attached hereto. Those skilled in the art will readily recognize various modifications and changes that may be made without following the example embodiments and applications illustrated and described herein, and without departing from the spirit and scope of the following claims.

What is claimed is:

1. An apparatus, comprising:
a non-transitory, machine-readable storage medium storing instructions; and
at least one processor coupled to the non-transitory, machine-readable storage medium, the at least one processor being configured to execute the instructions to:
receive flow data characterizing flow rates of a first fluid over a time range;
receive humidity data characterizing humidity levels over the time range;
receive temperature data characterizing temperatures over the time range;
generate a training set of features based on the flow data, the humidity data, and the temperature data;
train a machine learning process based on the training set of features; and
store machine learning model data characterizing the trained machine learning process in a data repository.

2. The apparatus of claim 1, wherein the at least one processor is configured to execute the instructions to:
receive thermostat data characterizing a temperature setting of a thermostat over the time range; and
generate the training set of features based on the thermostat data.

3. The apparatus of claim 2, wherein the thermostat data characterizes one or more changes to the setting of the thermostat.

4. The apparatus of claim 1, wherein the at least one processor is configured to execute the instructions to:
receive opinion data characterizing a satisfaction of comfortableness of one or more persons over the time range; and
generate the training set of features based on the opinion data.

5. The apparatus of claim 1, wherein the at least one processor is configured to execute the instructions to:
generate output data in response to training the machine learning process;
generate at least one metric value based on the output data; and
complete the training of the machine learning process based on the at least one metric value.

6. The apparatus of claim 1, wherein the at least one processor is configured to execute the instructions to:
establish the trained machine learning process based on the machine learning model data;
receive, from at least a first sensor, second flow data characterizing a flow rate of a fluid into a location;
receive, from at least a second sensor, second humidity data characterizing a humidity of the location;
receive, from at least a third sensor, second temperature data characterizing a temperature of the location;
generate an inference set of features based on the second flow data, the second humidity data, and the second humidity data; and
apply the trained machine learning process to the inference set of features to generate second output data.

7. The apparatus of claim 6, wherein the output data characterizes at least one of a predicted flow rate, a predicted humidity level, and a predicted temperature during a future temporal interval.

8. The apparatus of claim 6, wherein the at least one processor is configured to execute the instructions to adjust a flow rate setting based on the output data.

9. The apparatus of claim 8, wherein the flow rate setting is a liquid desiccant flow rate setting of a liquid desiccant air conditioning system.

10. The apparatus of claim 8, wherein the flow rate setting is a water flow rate setting of a liquid desiccant air conditioning system.

11. The apparatus of claim 8, wherein adjusting the flow rate setting causes a change to a ratio of supply air to exhaust air of a liquid desiccant air conditioning system.

12. The apparatus of claim 8, wherein adjusting the flow rate setting causes a change to a supply air flow rate.

13. The apparatus of claim 6, where the at least first sensor, the at least second sensor, and the at least third sensor are communicatively coupled to the at least one processor through a wireless network.

14. The apparatus of claim 6, wherein the at least one processor is configured to execute the instructions to provide a warning indication based on the output data.

15. The apparatus of claim 14, wherein the warning indication indicates at least one of an open door and open window.

16. A method by at least one processor, the method comprising:
receiving flow data characterizing flow rates of a first fluid over a time range;
receiving humidity data characterizing humidity levels over the time range;
receiving temperature data characterizing temperatures over the time range;
generating a training set of features based on the flow data, the humidity data, and the temperature data;
training a machine learning process based on the training set of features; and
storing machine learning model data characterizing the trained machine learning process in a data repository.

17. The method of claim 16, comprising:
receiving thermostat data characterizing a temperature setting of a thermostat over the time range; and
generating the training set of features based on the thermostat data.

18. The method of claim 16, comprising:
receiving opinion data characterizing a satisfaction of comfortableness of one or more persons over the time range; and
generating the training set of features based on the opinion data.

19. The method of claim 16, comprising:
generating output data in response to training the machine learning process;
generating at least one metric value based on the output data; and
completing the training of the machine learning process based on the at least one metric value.

20. A system comprising:
a conditioner sub-system configured to condition a stream of air based on a conditioning fluid;
a regenerator sub-system configured to remove heat from the conditioning fluid;
a controller configured to adjust at least one control setting of one or more of the conditioner sub-system and the regenerator sub-system; and
a computing device communicatively coupled to the controller, the computing device configured to:
receive, from at least one sensor, sensor data characterizing at least one of: a temperature, a humidity level, and a flow rate;
generate an inference set of features based on the sensor data;
apply a trained machine learning process to the inference set of features to generate output data characterizing a predicted operational value of one or more of the conditioner sub-system and the regenerator sub-system during a future temporal interval; and
based on the output data, transmit a signal to the controller to adjust the at least one control setting.
